(19) United States
(12) Patent Application Publication
(10) Pub. No.: US 2026/0345304 A1
(43) Pub. Date: Nov. 5, 2026

(54) ELECTRIC TOOTHBRUSH

(71) Applicant: NINGBO SEAGO ELECTRIC CO., LTD., Ningbo City (CN)

(72) Inventors: Yanzhong Cai, Ningbo City (CN); Weibing Peng, Ningbo City (CN); Yuli Wang, Ningbo City (CN)

(21) Appl. No.: 19/292,910

(22) Filed: Aug. 7, 2025

(30) Foreign Application Priority Data
Apr. 30, 2025 (CN) 202520857311.3

(51) Int. Cl. A61C 17/34

(52) U.S. Cl. CPC A61C 17/3472; A61C 17/3481; A61C 17/3454; A61C 17/3463

(57) ABSTRACT

An electric toothbrush comprises: a support frame provided with a hollow part; a drive frame comprising a frame body and a drive shaft extending from the frame body to an upper side of electric toothbrush, wherein the drive frame and the support frame are elastically connected through elastic parts, the frame body is located in the hollow part and spaced apart from the support frame in most regions, and the drive shaft is connected to a toothbrush head; and a drive element provided on the frame body and configured to drive the drive frame to swing or vibrate relative to support frame during operation, thereby enabling drive shaft to drive toothbrush head to swing or vibrate; each elastic part has smaller dimension along frontward/rearward direction of electric toothbrush than along leftward/rightward direction of electric toothbrush, causing drive shaft to have greater swing amplitude along frontward/rearward direction than along leftward/rightward direction.

### CROSS-REFERENCE TO RELATED APPLICATIONS

The present disclosure claims the priority to the Chinese patent application No. 202520857311.3 filed with the Chinese Patent Office on Apr. 30, 2025, and entitled “ELECTRIC TOOTHBRUSH”, the contents of which are incorporated herein by reference in entirety.

### TECHNICAL FIELD

The present disclosure relates to the technology field of oral hygiene and in particular to an electric toothbrush.

### BACKGROUND ART

An electric toothbrush produces high-frequency vibration in a toothbrush head by rapid rotation or vibration of an electric core, by which toothpaste is instantaneously decomposed into fine foam and deeply cleans gaps between teeth. Meanwhile, the fluttering of bristles can facilitate blood circulation in the oral cavity and has the effect of massaging gum tissue.

In the prior art, the eccentric block is driven by a motor to rotate to generate vibrations. However, such a structure has deficiencies in vibration frequency, vibration amplitude and force transmission. The vibration output to the toothbrush head is greatly attenuated, the vibration efficiency is low, the amplitude is small, and the cleaning effect is average.

### SUMMARY

In order to overcome or alleviate the problems existing in the above-mentioned prior art, the present disclosure aims to provide an electric toothbrush with better cleaning effect.

The present disclosure provides an electric toothbrush, comprising:
a support frame, wherein the support frame is provided with a hollow part;
a drive frame, wherein the drive frame comprises a frame body and a drive shaft extending from the frame body to an upper side of the electric toothbrush, the drive frame and the support frame are elastically connected through elastic parts, the frame body is located in the hollow part, the frame body and the support frame are spaced apart in most regions, the drive shaft is configured to connect a toothbrush head; and
a drive element, wherein the drive element is provided on the frame body, the drive element is able to drive the drive frame to swing or vibrate relative to the support frame during operation, so that the drive shaft is able to drive the toothbrush head to swing or vibrate; and
the dimension of each elastic part along the frontward/rearward direction of the electric toothbrush is smaller than the dimension of the elastic part along the leftward/rightward direction of the electric toothbrush, so that the swing amplitude of the drive shaft along the frontward/rearward direction is greater than the swing amplitude of the drive shaft along the leftward/rightward direction.

In at least one possible embodiment, the drive frame is connected to the support frame through a connecting part and the elastic parts, the connecting part is connected around the drive shaft, and in the upward/downward direction of the electric toothbrush, the connecting part and the frame body are spaced apart in the upward/downward direction of the electric toothbrush.

In at least one possible embodiment, one end of each elastic part is connected to the connecting part, and the other end of each elastic part is connected to the support frame, so that the elastic parts and the connecting part form a U-shape.

In at least one possible embodiment, the drive shaft and the connecting part are integrally molded and connected by injection molding.

In at least one possible embodiment, the elastic parts are in the shape of sheets extending in the leftward/rightward direction and the upward/downward direction of the electric toothbrush, and a size of the connecting part in the leftward/rightward direction of the electric toothbrush is the same as a size of each elastic part in the leftward/rightward direction of the electric toothbrush.

In at least one possible embodiment, the electric toothbrush further comprises a circuit board, and the circuit board is located at a front side of the support frame in the frontward/rearward direction.

In at least one possible embodiment, elastic part connection parts are provided at an upper end of the support frame, and the elastic part connection parts are located on both sides in the frontward/rearward direction of the electric toothbrush, and the elastic parts are connected to the support frame through the elastic part connection parts, and the elastic parts and the support frame are spaced apart in the frontward/rearward direction.

In at least one possible embodiment, in the upward/downward direction of the electric toothbrush, the drive shaft extends beyond an uppermost end of each elastic part.

In at least one possible embodiment, an eccentric block is connected to the output shaft of the drive element, and a counterweight is mounted on the drive frame, the drive element drives the eccentric block to rotate, which can make the drive frame swing or vibrate; and in the upward/downward direction of the electric toothbrush, the eccentric block is located on a lower side of the drive element, and the counterweight is located on a lower side of the eccentric block.

In at least one possible embodiment, the support frame is provided with a battery accommodating groove for mounting a battery.

According to the above-mentioned technical solutions, by making the size of each elastic part in the frontward/rearward direction smaller than the size of the elastic part in the leftward/rightward direction, the percussive amplitude of the drive shaft in the frontward/rearward direction is greater than the swing amplitude of the drive shaft in the leftward/rightward direction, so that the bristles of the toothbrush head percuss the tooth surface with a greater amplitude, which can more effectively clean the gaps between teeth and the gum line, massage the gums, promote blood circulation, and improve the brushing experience of the user.

### BRIEF DESCRIPTION OF DRAWINGS

FIG. 1 shows an exploded view of a partial structure of an electric toothbrush according to an embodiment of the present disclosure.

FIG. 2 shows a structural schematic diagram of a partial structure of an electric toothbrush according to an embodiment of the present disclosure.

FIG. 3 shows a side view of an electric toothbrush according to an embodiment of the present disclosure.

FIG. 4 shows a front view of an electric toothbrush according to an embodiment of the present disclosure.

FIG. 5 shows a rear view of an electric toothbrush according to an embodiment of the present disclosure.

FIG. 6 shows a structural schematic diagram of a support frame and a drive frame of the electric toothbrush according to the embodiment of the present disclosure.

FIG. 7 shows a partial enlarged view of an internal structure of the electric toothbrush according to the embodiment of the present disclosure.

### DESCRIPTION OF THE REFERENCE NUMERALS

100 toothbrush head;
1 support frame;
11 hollow part;
12 battery accommodating groove;
13 elastic part connecting part;
2 drive frame;
21 drive shaft;
22 motor groove;
23 counterweight groove;
24 elastic part;
25 connecting part;
26 frame body;
3 counterweight;
4 motor;
41 eccentric block;
5 shock absorber;
6 battery;
7 circuit board; b sealing ring;
9 waterproof ring;
A upward/downward direction;
F frontward/rearward direction;
R leftward/rightward direction.

### DETAILED DESCRIPTION OF EMBODIMENTS

In order to more clearly explain the above objectives, features, and advantages of the present disclosure, specific embodiments of the present disclosure are described in detail herein with reference to the drawings. The present disclosure can be implemented in other different ways in addition to the various embodiments described herein, and those skilled in the art can make corresponding improvements, variations, and replacements without departing from the spirit of the present disclosure, hence the present disclosure is not limited by the specific embodiments disclosed herein. The scope of protection of present disclosure shall be defined by the claims.

In the following description, an upward/downward direction A of an electric toothbrush represents a direction in which an axis of the electric toothbrush extends, where the upper side represents a side where a toothbrush head is located, and the lower side represents a side where a toothbrush handle is located. A frontward/rearward direction F of the electric toothbrush represents a direction in which bristles of the toothbrush head of the electric toothbrush extend, where the front side represents a side towards which the bristles face, and the rear side represents a side away from which the bristles face. A leftward/rightward direction R of the electric toothbrush is perpendicular to both the upward/downward direction A and the frontward/rearward direction F of the electric toothbrush.

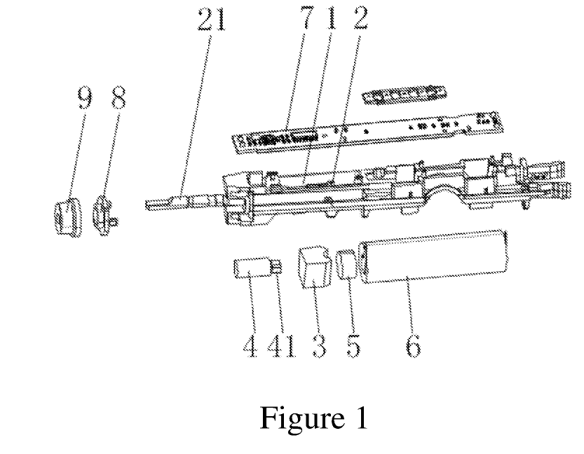

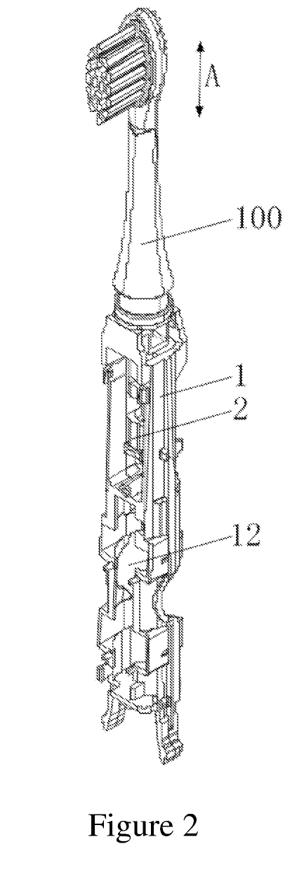

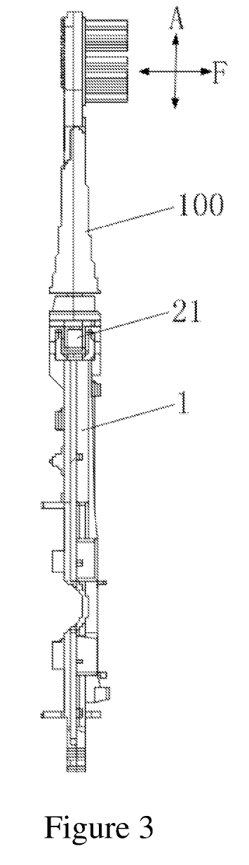

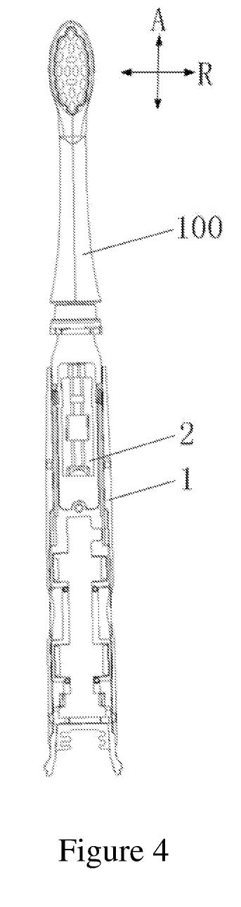

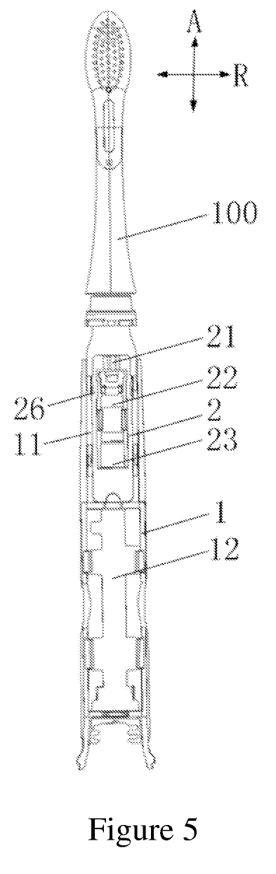

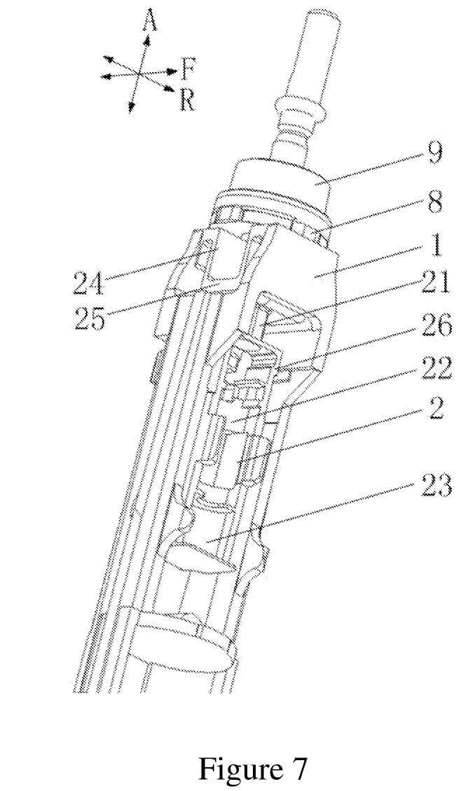

As shown in FIGS. 1-7, the embodiment of the present disclosure provides an electric toothbrush, where the electric toothbrush comprises a toothbrush handle and a toothbrush head 100, and the toothbrush head 100 can be mounted on an upper end of the toothbrush handle in a replaceable way.

The toothbrush handle comprises a housing (not shown), a support frame 1, a drive frame 2, a counterweight 3, a drive element (e.g., a motor 4), a shock absorber 5, a battery 6, a circuit board 7, a sealing ring 8, and a waterproof ring 9.

The support frame 1, the drive frame 2, the counterweight 3, the motor 4, the shock absorber 5, the battery 6, the circuit board 7, and the sealing ring 8 can be arranged inside the housing. The upper end of the housing has an opening, and the battery 6 and the circuit board 7 can be fixedly connected to the support frame 1. For example, the support frame 1 can be provided with a battery accommodating groove 12, and the battery 6 is mounted in the battery accommodating groove 12.

The circuit board 7 can be mounted on a front side of the support frame 1 in the frontward/rearward direction F, so that a button can be arranged on the front side of the housing, and the button can trigger a button (including a push button and a touch button) on the circuit board 7, which is convenient for the operator to use.

The counterweight 3, the motor 4, and the shock absorber 5 can be mounted on the drive frame 2, and the drive frame 2 and the support frame 1 can be elastically connected through the elastic parts 24. The vibration generated by the motor 4 during operation can drive a frame body 26 to swing or vibrate relative to the support frame 1, and then the swing or vibration is transmitted to the drive shaft 21, so that the drive shaft 21 drives the toothbrush head 100 to swing or vibrate.

The support frame 1 can be provided with a hollow part 11, and the hollow part 11 can be located at the upper side of the toothbrush handle in the upward/downward direction A, and the hollow part 11 can pass through the support frame 1 along the frontward/rearward direction F, and the hollow part 11 can be located in the middle position in the leftward/rightward direction R of the electric toothbrush.

The drive frame 2 can comprise a frame body 26 and a drive shaft 21 extending from the frame body 26 to the upper side in the upward/downward direction A of the electric toothbrush, the drive shaft 21 is configured to connect the toothbrush head 100, and the toothbrush head 100 can be connected to the drive shaft 21 in a detachable and replaceable way. The drive shaft 21 can be columnar. The drive shaft 21 can comprise a metal material and a plastic material, and the metal material has good rigidity.

The frame body 26 can comprise a motor groove 22, and the motor 4 can be accommodated in the motor groove 22. In the upward/downward direction A of the electric toothbrush, the drive shaft 21 can be located on the upper side of the motor groove 22. The output shaft of the motor 4 can be mounted with an eccentric block 41, so that vibration can be generated when the motor 4 rotates. In the upward/downward direction A of the electric toothbrush, the eccentric block 41 can be located on the lower side of the motor 4.

The drive frame 2 and the support frame 1 can be elastically connected through the elastic parts 24. For example, the frame body 26 can be elastically connected to the support frame 1 through the drive shaft 21, the connecting part 25 and the elastic parts 24. The frame body 26 can be located in the hollow part 11, and the frame body 26 and the support frame 1 are separated in most regions. For example, the frame body 26 is separated from the support frame 1 at least in the leftward/rightward direction R of the electric toothbrush, so that the frame body 26 can move relative to the support frame 1. By elastically connecting the drive frame 2 and the support frame 1 and separating them as a whole, the toothbrush head 100 connected to the drive shaft 21 can have a degree of freedom of movement, so that the toothbrush head 100 can be subjected to forces in different directions, thereby better cleaning teeth and massaging gums.

Further, each elastic part 24 is generally in the shape of a sheet extending in the leftward/rightward direction R and the upward/downward direction A. A dimension of an elastic part 24 along the frontward/rearward direction F of the electric toothbrush is smaller than a dimension of an elastic part 24 along the leftward/rightward direction R of the electric toothbrush. When the motor 4 drives the drive frame b to move, the drive frame 2 can easily percuss in relative to the support frame 1 in the frontward/rearward direction F, thereby driving the toothbrush head 100 to percuss in the frontward/rearward direction F. The percussive amplitude of the drive shaft 21 in the frontward/rearward direction F is greater than the swing amplitude of the drive shaft 21 in the leftward/rightward direction F. Therefore, the bristles of the toothbrush head 100 percusses the tooth surface with a greater amplitude and swing in a direction perpendicular to the tooth surface with a smaller amplitude, thereby increasing the force applied by the toothbrush head to the tooth surface, so that the electric toothbrush can more effectively clean the tooth gap position (interdental space) and the gum line.

Here, a size of the sheet-shaped elastic parts refers to a size of the entity of a single elastic part 24 of the two elastic parts 24, excluding the interval between the two elastic parts 24.

The drive shaft 21 drives the toothbrush head 100 to perform a frontward/rearward percussive action, which can make the toothbrush head 100 fit the gum line better, massage the gums, promote blood circulation, reduce the risk of gum bleeding, and at the same time, the stimulation to the gums is relatively gentle, thereby improving the brushing experience of the user. The frontward/rearward percussive action of the toothbrush head 100 can make the bristles better enter the small gaps between the teeth that are difficult to reach, thereby improving the cleaning effect.

It can be understood that the drive shaft 21 only has a large movement amplitude in the frontward/rearward direction F. In fact, the drive shaft 21 can move in multiple directions (including movement along the frontward/rearward direction F and movement along the leftward/rightward direction R) driven by the motor 4. This movement in multiple directions can not only make the bristles of the toothbrush head 100 cover different surfaces of the teeth, but also more effectively remove dirt and plaque in the gaps between the teeth.

The frame body 26 can comprise a counterweight groove 23, and the counterweight 3 can be accommodated in the counterweight groove 23. Optionally, in the upward/downward direction A of the electric toothbrush, the counterweight groove 23 can be located at the lower side of the motor groove 22, and the counterweight 3 can be located at the lower side of the eccentric block 41. In the upward/downward direction A of the electric toothbrush, the drive shaft 21 can be located at the upper side of the motor groove 22, and the counterweight groove 23 can be located at the lower side of the motor groove 22. The counterweight 3 can increase the overall weight of the drive frame 2, balance the vibration generated when the motor is running, avoid imbalance caused by vibration, keep the electric toothbrush stable during use, and make the movement of the toothbrush head more stable and efficient.

The drive shaft 21 can be connected to the elastic parts 24 through the connecting part 25, and the connecting part 25 can be sheet-shaped, and the connecting part 25 can surround the drive shaft 21. In the upward/downward direction A of the electric toothbrush, the connecting part 25 can be separated from the frame body 26 by a distance. The connecting part 25 is connected to the support frame 1 through two elastic parts 24, and the elastic parts 24 can be located on the front and rear sides of the connecting part 25 in the frontward/rearward direction F.

When viewed along the leftward/rightward direction R of the electric toothbrush, the thickness of the connecting part 25 can be greater than the thickness of each of the elastic parts 24. It can be understood that the thickness of the connecting part 25 can be adaptively changed according to design requirements. The elastic parts 24 can enable the motor 4 to drive the frame body to swing or vibrate relative to the support frame 1. The elastic parts 24 can absorb and buffer the external force (especially the external force along the frontward/rearward direction F), such as vibration or impact during use, to reduce damage to the overall structure, and improve service life and grip comfort.

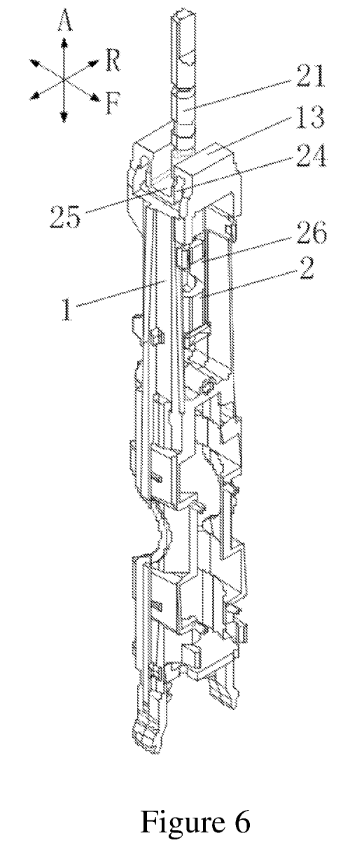

The cross-section of the elastic parts 24 (the cross-section in the direction perpendicular to the upward/downward direction A) can be rectangular, and a size of the connecting part 25 along the leftward/rightward direction R of the electric toothbrush and a size of the elastic parts 24 along the leftward/rightward direction R of the electric toothbrush can be the same (including substantially the same). One end of one of the elastic parts 24 (the lower end in FIG. 6) can be connected to the connecting part 25, and the other end of the one of the elastic parts 24 (the upper end in FIG. 6) can be connected to the support frame 1, so that the elastic parts 24 and the connecting part 25 can form a U shape.

The upper end of the support frame 1 can be provided with an elastic part connecting part 13, and two elastic part connecting parts 13 can be provided, and the two elastic part connecting parts 13 can be located at the front and rear sides of the drive shaft 21 in the frontward/rearward direction F of the electric toothbrush. The elastic parts 24 can be connected to the support frame 1 through the elastic part connecting part 13, and the elastic parts 24 and the support frame 1 are spaced apart in the frontward/rearward direction F.

The waterproof ring 9 can be mounted at the front end of the housing of the toothbrush handle, and the waterproof ring 9 can cover the opening of the housing of the toothbrush handle, and the drive shaft 21 can extend out the waterproof ring 9.

For example, two sealing ring mounting holes (not shown in the drawings) can be provided at the front end of the support frame 1, and the two sealing ring mounting holes can be provided at the elastic part connecting part 13. The sealing ring 8 can be sleeved on the drive shaft 21, and the fixing claw of the sealing ring 8 can be mounted in the sealing ring mounting hole. The sealing ring 8 can prevent water or foam from entering the interior of a main body 100, and the sealing ring 8 can reduce the impact of vibration on the waterproof ring 9, thereby improving the sealing effect.

The drive shaft 21 can have a fulcrum. It can be understood that the fulcrum is a virtual position defined by humans, and is not a support point that exists in the structure. When the motor 4 drives the drive frame 2 to swing or vibrate, the drive frame 2 can swing or vibrate around the fulcrum. It can be understood that the fulcrum can also be allowed to move within a range. For example, the amplitude near the fulcrum can be controlled within 0.1 mm to 0.5 mm, which can reduce the vibration resistance of the fulcrum area, so that the vibration energy of the motor 4 can be more concentratedly transmitted to the elastic parts 24, thereby improving the vibration transmission efficiency. Near the fulcrum, the vibration energy is concentrated, and the impact of excess vibration on the sealing ring 8 can be reduced by the vibration absorption effect of the elastic parts 24. At the position of the toothbrush head far from the fulcrum, the drive shaft 21 releases vibration energy, amplifies the swing amplitude, and improves the cleaning effect.

As shown in FIG. 6, the drive shaft 21 can extend in the upward/downward direction A to the uppermost end beyond the elastic parts 24. The longer drive shaft 21 can make the toothbrush head 100 farther away from the fulcrum, and the lever principle can be used to make the movement amplitude of the toothbrush head 100 larger.

Optionally, in this embodiment, the elastic parts 24, the connecting part 25, the frame body and the support frame 1 can all be made of plastic material, and the elastic parts 24, the connecting part 25, the frame body and the support frame 1 can be integrally molded. The drive shaft 21 is made of metal, and the drive shaft 21 and the connecting part 25 can be integrally molded and connected by injection molding. This can reduce assembly and mounting errors and wear of contact mating, and make the overall structural strength and stability of the support frame 1 and the drive frame 2 higher.

Optionally, the shock absorber 5 can be connected to the drive frame 2, and at least a portion of the shock absorber 5 can be located in the gap between the drive frame 2 and the support frame 1. The shock absorber 5 is elastic, for example, the shock absorber 5 can be foam or rubber. When the drive frame swings or vibrates, the shock absorber 5 can effectively absorb and alleviate the vibration transmitted to the support frame 1, reduce the vibration intensity transmitted to the hand of the user, and improve the comfort of use. The shock absorber 5 can protect the motor 4 and other components by buffering the vibration, and can also reduce the noise generated by the running of the motor 4, so that the electric toothbrush is quieter during use to improve the user experience. In addition, the shock absorber 105 can also buffer external impacts, reduce damage caused by falling, and extend the service life of the electric toothbrush.

When using the electric toothbrush of the present disclosure, the electric toothbrush is turned on, connecting the power to make the motor 4 start to rotate. The motor 4 drives the eccentric block 41 to rotate, so that the frame body swings or vibrates with the fulcrum as the axis, and transmits power to the drive shaft 21. The frame body and the toothbrush head are located at the two ends of the fulcrum respectively. The lever principle is used to amplify the swing or vibration of the frame body at the position of the bristles of the toothbrush head. The movement amplitude of the toothbrush head 15 mounted on the drive shaft 21 can reach 3 to 5 mm, so that the cleaning effect is better.

The electric toothbrush of the present disclosure has the following beneficial effects.
(1) By making the size of the elastic parts 24 along the frontward/rearward direction F smaller than the size of the elastic parts 24 along the leftward/rightward direction R, the percussive amplitude of the drive shaft 21 along the frontward/rearward direction F is greater than the swinging amplitude of the drive shaft 21 along the leftward/rightward direction R, so that the bristles of the toothbrush head 100 can percuss the tooth surface with a greater amplitude, which can more effectively clean the gaps between teeth and the gum line, massage the gums, promote blood circulation, and improve the brushing experience of the user.
(2) The motor 4 drives the drive frame 2 to swing or vibrate relative to the support frame 1, thereby driving the drive shaft 21 to make the toothbrush head swing or vibrate synchronously. This design can effectively reduce the vibration transmitted to the toothbrush handle, thereby reducing energy consumption and improving the brushing effect. In addition, the structure is simple and can easily convert the rotational motion of the motor 4 into the swing or vibration of the drive shaft 21, making the production cost lower.
(3) The vibration is transmitted to the drive shaft 21 through the elastic parts 24, which can achieve amplitude difference in the vibration transmission path. The amplitude near the fulcrum is smaller, so that the sealing ring 8 is not excessively squeezed and deformed by the drive shaft 21, and the sealing effect is better. In addition, the amplitude is larger at the upper end of the drive shaft 21, so that the cleaning efficiency of the toothbrush head is higher.
(4) The drive shaft 21, the elastic parts 24, the connecting part 25 and the support frame 1 are integrally formed, so that the overall structural strength of the support frame 1 and the drive frame 2 is high and the stability is good, thereby avoiding the loose connection and the decrease of the vibration transmission efficiency caused by long-term vibration.
(5) The elastic parts 24 can absorb and buffer the vibration of the drive frame 2, so that the vibration is less transmitted to the toothbrush handle and then to the hand of the user, reducing the vibration intensity transmitted to the hand of the user, improving the comfort of use, and reducing noise, making the electric toothbrush quieter during use and improving the user experience.
(6) The elastic parts 24 have a simple structure, and the integrally formed design is easy to manufacture and assemble, and the production cost is low.

It should be understood that at least some of the aspects or features of the above embodiments, implementations, or examples can be appropriately combined with each other.

It can be understood that, in the present disclosure, when the number of parts or components is not specifically limited, the number thereof can be one or multiple, where the term "multiple" refers to two or more. In the case where the number of parts or components shown in the drawings and/or described in the description is a specific quantity, such as two, three, or four, the specific quantity is usually exemplary and not restrictive and can be construed as multiple, i.e., two or more, however, this does not mean that the number “one” is excluded in the present disclosure.

In the present disclosure, unless otherwise expressly stated or defined, the terms "mount", "assemble", "assembling", "couple", "connect", "link", "attach", "abut", "communicate", “communicating”, "conduct”, "fix", "fasten", and the like should be construed in a broad sense, for example, directly or indirectly. For example, connection can be fixed connection, detachable connection, or integral connection, or can be mechanical connection or electrical connection, or can be direct connection or indirect connection through an intermediate medium, or internal communication between two elements or interaction between two elements, unless otherwise expressly stated or defined. For example, communication/conduction or the like can be direct communication/conduction, or indirect communication/conduction through an intermediate medium. It will be appreciated by those of ordinary skill in the art that the specific meanings of the above terms in the present disclosure can be understood according to specific situations.

In the present disclosure, unless otherwise expressly stated or defined, a component arranged/mounted/positioned/accommodated/disposed in, within, or inside another component can be either of: the component partially or mostly positioned within another component; and the component wholly accommodated within another component.

Although the present disclosure is described in detail using the above embodiments, it is apparent to those skilled in the art that the present disclosure is not limited to the embodiments described in this specification. The present disclosure can be modified and implemented as a variant embodiment without departing from the spirit and scope of the present disclosure determined by the claims. Therefore, the description in this specification is for illustrative purposes only and is not intended to limit the present disclosure in any way.

1. An electric toothbrush, wherein the electric toothbrush comprises:
a support frame, wherein the support frame is provided with a hollow part;
a drive frame, wherein the drive frame comprises a frame body and a drive shaft extending from the frame body to an upper side of the electric toothbrush, the drive frame and the support frame are elastically connected through elastic parts, the frame body is located in the hollow part, the frame body and the support frame are spaced apart in most regions, the drive shaft is configured to connect a toothbrush head; and
a drive element, wherein the drive element is provided on the frame body, the drive element is able to drive the drive frame to swing or vibrate relative to the support frame during operation, so that the drive shaft is able to drive the toothbrush head to swing or vibrate; and
a dimension of each elastic part along a frontward/rearward direction of the electric toothbrush is smaller than a dimension of the elastic part along a leftward/rightward direction of the electric toothbrush, so that a swing amplitude of the drive shaft along the frontward/rearward direction is greater than the swing amplitude of the drive shaft along the leftward/rightward direction.

2. The electric toothbrush according to claim 1, wherein the drive frame is connected to the support frame through a connecting part and the elastic parts, the connecting part is connected around the drive shaft, and in an upward/downward direction of the electric toothbrush, the connecting part and the frame body are spaced apart in the upward/downward direction of the electric toothbrush.

3. The electric toothbrush according to claim 2, wherein one end of each elastic part is connected to the connecting part, and the other end of each elastic part is connected to the support frame, so that the elastic parts and the connecting part form a U shape.

4. The electric toothbrush according to claim 2, wherein the drive shaft and the connecting part are integrally molded and connected by injection molding.

5. The electric toothbrush according to claim 2, wherein the elastic parts are in a shape of sheets extending in the leftward/rightward direction and the upward/downward direction of the electric toothbrush, and a size of the connecting part in the leftward/rightward direction of the electric toothbrush is the same as a size of each elastic part in the leftward/rightward direction of the electric toothbrush.

6. The electric toothbrush according to claim 2, wherein the electric toothbrush further comprises a circuit board, and the circuit board is located on a front side of the support frame in the frontward/rearward direction.

7. The electric toothbrush according to claim 1, wherein elastic part connecting parts are provided at an upper end of the support frame, the elastic part connecting parts are located on both sides in the frontward/rearward direction of the electric toothbrush, the elastic parts are connected to the support frame through the elastic part connecting parts, and the elastic parts and the support frame are spaced apart in the frontward/rearward direction.

8. The electric toothbrush according to claim 1, wherein, in the upward/downward direction of the electric toothbrush, the drive shaft extends beyond an uppermost end of each elastic part.

9. The electric toothbrush according to claim 1, wherein an eccentric block is connected to an output shaft of the drive element, a counterweight is mounted on the drive frame, the drive element drives the eccentric block to rotate so that the drive frame is able to swing or vibrate; and in the upward/downward direction of the electric toothbrush, the eccentric block is located on a lower side of the drive element, and the counterweight is located on a lower side of the eccentric block.

10. The electric toothbrush according to claim 1, wherein the support frame is provided with a battery accommodating groove for mounting a battery.
